(19) United States
(12) Patent Application Publication
(10) Pub. No.: US 2007/0197731 A1
(43) Pub. Date: Aug. 23, 2007

(54) Process for producing thermoplastic resin composition

(75) Inventor: Shinichi Kondo, Ichihara-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/707,068

(22) Filed: Feb. 16, 2007

(30) Foreign Application Priority Data
Feb. 20, 2006 (JP) 2006-042076

(51) Int. Cl. C08F 8/00

(52) U.S. Cl. 525/192

(57) ABSTRACT

A process for producing a thermoplastic resin composition comprising the steps of (1) reacting with one another, at least, 0.1 to 100% by weight of an amorphous olefin copolymer resin (a1), 0 to 99.9% by weight of a crystalline polyolefin resin (a2), 0.01 to 20 parts by weight of a compound (b) containing at least one kind of an unsaturated group (b1) and at least one kind of a polar group (b2), and 0.001 to 20 parts by weight of an organic peroxide (c), thereby producing a modified polyolefin resin (A), and (2) blending 1 to 99% by weight of said modified polyolefin resin (A) with 1 to 99% by weight of a crystalline thermoplastic resin (B).

### FIELD OF THE INVENTION

The present invention relates to a process for producing a thermoplastic resin composition.

### BACKGROUND OF THE INVENTION

JP 8-311293A discloses a modified resin composition, which comprises 20 to 80% by weight of an acid-modified amorphous polyolefin and 80 to 20% by weight of a crystalline thermoplastic resin.

### SUMMARY OF THE INVENTION

However, there is a problem in that (1) it is not always easy to produce stably said modified resin composition; and (2) when coating an agent such as a paint on said modified resin composition, adhesion of coating of said agent with said modified resin composition is not always sufficient.

In view of the above-mentioned problem in the conventional art, the present invention has an object to provide a process for producing a thermoplastic resin composition, which can be produced stably, and which has excellent adhesion with such coating.

The present invention is a process for producing a thermoplastic resin composition comprising the steps of:

(1) reacting with one another, at least, 0.1 to 100% by weight of an amorphous olefin copolymer resin (a1), 0 to 99.9% by weight of a crystalline polyolefin resin (a2), 0.01 to 20 parts by weight of a compound (b) containing at least one kind of an unsaturated group (b1) and at least one kind of a polar group (b2), and 0.001 to 20 parts by weight of an organic peroxide (c), thereby producing a modified polyolefin resin (A), the total amount of said resin (a1) and said resin (a2) being 100% by weight or 100 parts by weight; and

(2) blending 1 to 99% by weight of said modified polyolefin resin (A) with 1 to 99% by weight of a crystalline thermoplastic resin (B), the total amount of said resin (A) and said resin (B) being 100% by weight,

wherein said amorphous olefin copolymer resin (a1) has a molecular weight distribution of 1 to 4, an intrinsic viscosity of 0.5 to 10 dL/g measured at 135° C. in tetrahydronaphthalene, and crystal melting heat of 30 J/g or less in a range of −50 to 200° C. measured by differential scanning calorimetry (DSC) according to JIS K7122; said crystalline polyolefin resin (a2) has a peak of crystal melting heat of 1 J/g or more, or a peak of crystallization heat of 1 J/g or more in a range of 50 to 180° C. measured by differential scanning calorimetry according to JIS K7122; and said crystalline thermoplastic resin (B) has a peak of crystal melting heat of 1 J/g or more, or a peak of crystallization heat of 1 J/g or more in a range of 50 to 180° C. measured by differential scanning calorimetry according to JIS K7122.

The above-mentioned “amorphous olefin copolymer resin (a1)” and “crystalline polyolefin resin (a2)” are referred to hereinafter as simply “resin (a1)” and “resin (a2)”, respectively. The above-mentioned “JIS” is an abbreviation of Japanese Industrial Standards.

### DETAILED DESCRIPTION OF THE INVENTION

The resin (a1) in the present invention means an amorphous olefin copolymer resin obtained by copolymerizing two or more kinds of monomers selected from the group consisting of ethylene, propylene, an α-olefin having 4 to 20 carbon atoms and a cyclic olefin.

Examples of the α-olefin having 4 to 20 carbon atoms are a linear α-olefin such as 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, and 1-eicosene; and a branched α-olefin such as 3-methyl-1-butene, 3-methyl-1-pentene, 4-methyl-1-pentene, 2-ethyl-1-hexene, and 2,2,4-trimethyl-1-pentene.

Examples of the cyclic olefin are cyclobutene, cyclopentene, cyclopentadiene, 4-methylcyclopentene, 4,4-dimethylcyclopentene, cyclohexene, 4-methylcyclohexene, 4,4-dimethylcyclohexene, 1,3-dimethylcyclohexene, 1,3-cyclohexadiene, 1,4-cyclohexadiene, cycloheptene, 1,3-cycloheptadiene, 1,3,5-cycloheptatriene, cyclooctene, 1,5-cyclooctadiene, and cyclododecene.

In order to produce stably the modified polyolefin resin (A), the above-mentioned two or more kinds of monomers composing the resin (a1) is preferably a combination of monomers, which has the number of a carbon atom of 6 or larger in total. For example, in case of a combination of ethylene (C₂) with 1-butene (C₄), said number is 6 in total.

Examples of the resin (a1) are a copolymer of two kinds of monomers such as an ethylene-1-butene copolymer, an ethylene-1-hexene copolymer, an ethylene-1-octene copolymer, an ethylene-1-decene copolymer, an ethylene-1-octadecene copolymer, an ethylene-4-methyl-1-pentene copolymer, a propylene-1-butene copolymer, a propylene-1-hexene copolymer, a propylene-1-octene copolymer, a propylene-1-decene copolymer, a propylene-1-octadecene copolymer, a propylene-4-methyl-1-pentene copolymer, a 1-butene-1-hexene copolymer, a 1-butene-1-octene copolymer, a 1-butene-1-decene copolymer, a 1-butene-1-octadecene copolymer, a 1-butene-4-methyl-1-pentene copolymer, a 1-hexene-1-octene copolymer, a 1-hexene-1-decene copolymer, a 1-hexene-1-octadecene copolymer, a 1-hexene-4-methyl-1-pentene copolymer, a 1-octene-1-decene copolymer, a 1-octene-1-octadecene copolymer, a 1-octene-4-methyl-1-pentene copolymer, a 1-decene-1-octadecene copolymer, a 1-decene-4-methyl-1-pentene copolymer, and a 1-octadecene-4-methyl-1-pentene copolymer; a copolymer of three kinds of monomers such as an ethylene-propylene-1-butene copolymer, an ethylene-propylene-1-hexene copolymer, an ethylene-propylene-1-octene copolymer, an ethylene-propylene-1-decene copolymer, an ethylene-propylene-1-octadecene copolymer, an ethylene-propylene-4-methyl-1-pentene copolymer, an ethylene-1-butene-1-hexene copolymer, an ethylene-1-butene-1-octene copolymer, an ethylene-1-butene-1-decene copolymer, an ethylene-1-butene-1-octadecene copolymer, an ethylene-1-butene-4-methyl-1-pentene copolymer, an ethylene-1-hexene-1-octene copolymer, an ethylene-1-hexene-1-decene copolymer, an ethylene-1-hexene-1-octadecene copolymer, an ethylene-1-hexene-4-methyl-1-pentene copolymer, an ethylene-1-octene-1-decene copolymer, an ethylene-1-octene-1-octadecene copolymer, an ethylene-1-octene-4-methyl-1-pentene copolymer, an ethylene-1-decene-1-octadecene copolymer, an ethylene-1-decene-4-methyl-1-pentene copolymer, an ethylene-1-octadecene-4-methyl-1-pentene copolymer, a propylene-1-butene-1-hexene copolymer, a propylene-1-butene-1-octene copolymer, a propylene-1-butene-1-decene copolymer, a propylene-1-butene-1-octadecene copolymer, a propylene-1-butene-4-methyl-1-pentene copolymer, a propylene-1-hexene-1-octene copolymer, a propylene-1-hexene-1-decene copolymer, a propylene-1-hexene-1-octadecene copolymer, a propylene-1-hexene-4-methyl-1-pentene copolymer, a propylene-1-octene-1-decene copolymer, a propylene-1-octene-1-octadecene copolymer, a propylene-1-octene-4-methyl-1-pentene copolymer, a propylene-1-decene-1-octadecene copolymer, a propylene-1-decene-4-methyl-1-pentene copolymer, a propylene-1-octadecene-4-methyl-1-pentene copolymer, a 1-butene-1-hexene-1-octene copolymer, a 1-butene-1-hexene-1-decene copolymer, a 1-butene-1-hexene-1-octadecene copolymer, a 1-butene-1-hexene-4-methyl-1-pentene copolymer, a 1-butene-1-octene-1-decene copolymer, a 1-butene-1-octene-1-octadecene copolymer, a 1-butene-1-octene-4-methyl-1-pentene copolymer, a 1-butene-1-decene-1-octadecene copolymer, a 1-butene-1-decene-4-methyl-1-pentene copolymer, and a 1-butene-1-octadecene-4-methyl-1-pentene copolymer; and a copolymer of four kinds of monomers such as an ethylene-propylene-1-butene-1-hexene copolymer, an ethylene-propylene-1-butene-1-octene copolymer, an ethylene-propylene-1-butene-1-decene copolymer, an ethylene-propylene-1-butene-1-octadecene copolymer, an ethylene-propylene-1-butene-4-methyl-1-pentene copolymer, an ethylene-1-butene-1-hexene-1-octene copolymer, an ethylene-1-butene-1-hexene-1-decene copolymer, an ethylene-1-butene-1-hexene-1-octadecene copolymer, an ethylene-1-butene-1-hexene-4-methyl-1-pentene copolymer, an ethylene-propylene-1-hexene-1-octene copolymer, an ethylene-propylene-1-hexene-1-decene copolymer, an ethylene-propylene-1-hexene-1-octadecene copolymer, and an ethylene-propylene-1-hexene-4-methyl-1-pentene copolymer. Those copolymers are used singly or in combination of two or more thereof.

The resin (a1) has a molecular weight distribution of 1 to 4, and preferably 1 to 3, in order to improve adhesion of the thermoplastic resin composition in the present invention with coating, the molecular weight distribution being represented by a ratio (Mw/Mn) of a weight average molecular weight (Mw) to a number average molecular weight (Mn). Said Mw, Mn and Mw/Mn are measured by GPC (gel permeation chromatography) using a solution of about 5 mg of the resin (a1) in 5 mL of o-dichlorobenzene under the following conditions:

(1) a GPC apparatus, 150C/GPC (trade name), manufactured by Waters is used:

(2) a column, SHODEX PACKED COLUMN A-80M (trade name), manufactured by Showa Denko K.K. is used:

(3) 400 μL of the above-mentioned solution is injected:

(4) elution temperature is 140° C.:

(5) a flow velocity of an elution solvent is 1.0 mL/minute:

(6) a refractive index detector is used:

(7) a molecular standard material is polystyrene having a molecular weight of 6,800,000 to 8,400,000 manufactured by Tosoh Corporation: and

(8) Mw and Mn of the resin (a1) are measured in terms of a molecular weight of polystyrene, and then, Mw/Mn is calculated.

A number average molecular weight of the resin (a1) is preferably 50,000 to 2,000,000, and more preferably 70,000 to 1,300,000, in order to produce stably the modified polyolefin resin (A) in the step (1).

An intrinsic viscosity of the resin (a1) measured at 135° C. in tetrahydronaphthalene is 0.5 to 10 dL/g, preferably 0.7 to 7 dL/g, and more preferably 1 to 5 dL/g, in order to produce stably the modified polyolefin resin (A) in the step (1).

Crystal melting heat of the resin (a1) in a range of −50 to 200° C. measured by differential scanning calorimetry according to JIS K7122 is 30 J/g or less, preferably 20 J/g or less, and more preferably 10 J/g or less. The crystal melting heat of more than 30 J/g may result in insufficient adhesion of the thermoplastic resin composition in the present invention with coating.

The resin (a1) contains an ethylene unit in amount of 0 to 60% by mole, and preferably 0 to 55% by mole, the total amount of all monomer units contained in the resin (a1) being 100% by mole. The amount of larger than 60% by mole may result in insufficient adhesion of the thermoplastic resin composition in the present invention with coating. The above-mentioned term “unit” means a polymerized monomer unit.

The resin (a1) is preferably an olefin copolymer having an atactic structure, in order to improve adhesion of the thermoplastic resin composition in the present invention with coating. It is more preferable that the resin (a1) contains polymerized monomer units derived from two or more kinds of monomers, and all side chains contained in the polymerized monomer units have an atactic structure.

The resin (a1) is more preferably an olefin copolymer having neither a peak of crystal melting heat of 1 J/g or more, nor a peak of crystallization heat of 1 J/g or more in a range of −50 to 200° C. measured by differential scanning calorimetry according to JIS K7122.

The resin (a1) is produced preferably using a metallocene catalyst in order to produce an olefin copolymer having a narrow molecular weight distribution. An example of the metallocene catalyst is a complex of a transition metal of the groups 4 to 6 in the periodic table of elements having at least one cyclopentadienyl type anion skeleton. Specific examples of the metallocene catalyst are those disclosed in JP 9-151205A (corresponding to EP 708117A), JP 58-19309A (corresponding to U.S. Pat. No. 4,542,199A), JP 60-35005A (corresponding to U.S. Pat. No. 4,536,484A), JP 60-35006A (corresponding to U.S. Pat. No. 4,937,299A), JP 60-35007A (corresponding to U.S. Pat. No. 5,324,800A), JP 60-35008A (corresponding to U.S. Pat. No. 4,530,914A), JP 61-130314A (corresponding to U.S. Pat. No. 4,769,510A), JP 3-163088A (corresponding to U.S. Pat. No. 5,703,187A), JP 4-268307A (corresponding to U.S. Pat. No. 5,243,001A), JP 9-12790A (corresponding to EP 751182A), JP 9-87313A (corresponding to U.S. Pat. No. 6,329,478A), JP 11-193309A (corresponding to U.S. Pat. No. 6,084,048A), JP 11-80233A (corresponding to U.S. Pat. No. 6,121,401A), or WO 10-508055A (corresponding to U.S. Pat. No. 5,986,029A).

A metallocene catalyst used for production of the resin (a1) is preferably a polymerization catalyst obtained by contacting at least one kind of a transition metal complex (d) represented by the following formulas [I] to [III] with at least one kind of an aluminum compound (e) of the following compounds (e1) to (e3) and/or any one kind of a boron compound (f) of the following compounds (f1) to ([3):

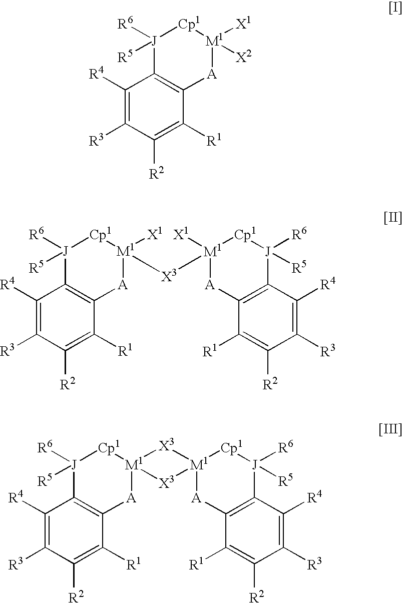

wherein M¹ is the group 4 transition metal atom in the periodic table of elements; A is the group 16 atom therein; J is the group 14 atom therein; Cp¹ is a cyclopentadienyl type anion skeleton-carrying group; X¹, X², R¹, R², R³, R⁴, R⁵ and R⁶ are independently of one another a hydrogen atom, a halogen atom, an alkyl group, an aralky group, an aryl group, a substituent-carrying silyl group, an alkoxy group, an aralkyloxy group, an aryloxy group, or a disubstituent-carrying amino group, and any two of R¹, R², R³, R⁴, R⁵ and R⁶ may be linked to each other to form a ring; X³ is the group 16 atom in the periodic table of elements; and two M¹s, two As, two Js, two Cp¹s, two X¹s, two X²s, two X³s, two R¹s, two R²s, two R³s, two R⁴s, two R⁵s or two R⁶s in the formula [II] or [III] are the same as or different from each other,

(e1) an organic aluminum compound represented by the formula E^{I}ₐAlZ₃₋ₐ,

(e2) a cyclic aluminoxane having a structure represented by the formula {—Al(E²)—O—}_{b}, and

(e3) a linear aluminoxane having a structure represented by the formula E³{-Al(E³)—O—}_{c}AlE³₂,

wherein each of E¹, E² and E³ is a hydrocarbyl group, and plural E¹s, E²s and E³s are the same as or different from one another;
Z is a hydrogen atom or a halogen atom, and plural Zs are the same as or different from one another; a is an integer satisfying 0<a≦3; b is an integer of 2 or more; and c is an integer of 1 or more, and

(f1) a boron compound represented by the formula BQ¹Q²Q³,

(f2) a boron compound represented by the formula G⁺(BQ⁴Q⁵Q⁶Q⁷)⁻, and

(f3) a boron compound represented by the formula (L-H)⁺(BQ⁸Q⁹Q¹⁰Q¹¹)⁻,

wherein Q¹ to Q¹¹ are independently of one another a halogen atom, a hydrocarbyl group, a halogenated hydrocarbyl group, a substituent-having silyl group, an alkoxy group, or a disubstituent-having amino group; G⁺ is an inorganic or organic cation; L is a neutral Lewis base; and (L-H)⁺ is a Broensted acid.

The above-mentioned transition metal complex (d), aluminum compound (e) and boron compound (f) are disclosed in detail in the above-mentioned JA 11-80233A, column 10, line 4 to column 33, line 44 (corresponding to U.S. Pat. No. 6,121,401A, column 5, line 10 to column 19, line 63).

When the boron compound (f) is not used (namely, when the transition metal complex (d) and the aluminum compound (e) are used), the aluminum compound (e) is preferably the cyclic aluminoxane (e2), the linear aluminoxane (e3), or a combination thereof (e2+e3). Preferred is a combination of the transition metal complex (d), the aluminum compound (e) and the boron compound (f) wherein the aluminum comrpound (e) is preferably the organic aluminum compound (e1).

The aluminum compound (e) is used in amount of usually 0.1 to 10,000 moles, and preferably 5 to 2,000 moles per 1 mole of the transition metal complex (d). The boron compound (f) is used in amount of usually 0.01 to 100 moles, and preferably 0.5 to 10 moles per 1 mole of the transition metal complex (d).

When using the transition metal complex (d), the aluminum compound (e) or the boron compound (f) in its solution state or suspension state, a concentration of the solution or suspension of the transition metal complex (d) is preferably 0.01 to 500 μmole, more preferably 0.05 to 100 μmole, and further preferably 0.05 to 50 μmole per 1 g of the solution or suspension; a concentration of the solution or suspension of the aluminum compound (e) is preferably 0.01 to 10,000 μmole, more preferably 0.1 to 5,000 μmole, and further preferably 0.1 to 2,000 μmole in terms of an amount of an aluminum atom contained in the aluminum compound (e), per 1 g of the solution or suspension; and a concentration of the solution or suspension of the boron compound (f) is preferably 0.01 to 500 μmole, more preferably 0.05 to 200 μmole, and further preferably 0.05 to 100 μmole per 1 g of the solution or suspension. Those concentrations are suitably selected within the above-mentioned ranges according to a reactor to which those solutions or suspensions are supplied.

Examples of a polymerization method for producing the resin (a1) are a solution or slurry polymerization method using a solvent, and a gas phase polymerization method polymerizing a gaseous monomer. Examples of said solvent are an aliphatic hydrocarbon such as butane, pentane, hexane, heptane and octane; an aromatic hydrocarbon such as benzene and toluene; and a halogenated hydrocarbon such as methylene dichloride. Examples of a polymerization system for producing the resin (a1) are a continuous polymerization system and a batch-wise polymerization system. Its polymerization temperature is usually −50 to 200° C., and preferably −20 to 100° C. Its polymerization pressure is preferably ordinary pressure to 60 kg/cm²G. Its polymerization time is suitably determined according to the kind of a catalyst used and/or a reactor used, and is generally 1 minute to 20 hours. In order to control a molecular weight of a copolymer obtained, a chain transfer agent such as hydrogen may be used.

The resin (a2) is a crystalline polyolefin resin having a peak of crystal melting heat of 1 J/g or more, and preferably more than 30 J/g, or a peak of crystallization heat of 1 J/g or more, and preferably more than 30 J/g in a range of 50 to 180° C. measured by differential scanning calorimetry according to JIS K7122.

Examples of the resin (a2) are a crystalline polyethylene resin such as a crystalline high density polyethylene, a crystalline medium density polyethylene, a crystalline low density polyethylene, and a crystalline linear low density polyethylene; a crystalline polypropylene resin; a crystalline polybutene resin; and a crystalline poly(4-methyl-1-pentene) resin. Among them, preferred is a crystalline polypropylene resin. Examples of said crystalline polypropylene resin are (1) a homopolymer of propylene, (2) a propylene random copolymer, which contains 51 to 99.99% by weight of a propylene unit and 0.01 to 49% by weight of an olefin unit of one or more kinds of olefins selected from the group consisting of ethylene and an α-olefin having four or more carbon atoms, the total of the former propylene unit and the latter olefin unit being 100% by weight, (3) an ethylene-propylene block copolymer, which contains 55 to 95 parts by weight of a propylene homopolymer (which is referred to as “first polymer”), and 5 to 45 parts by weight of an ethylene-propylene random copolymer (which is referred to as “second polymer”) containing 20 to 90% by weight of a propylene unit and 10 to 80% by weight of an ethylene unit, the total of the first polymer and the second polymer being 100 parts by weight, and the total of the former propylene unit and the latter ethylene unit being 100% by weight, (4) a propylene-α-olefin block copolymer, which contains 55 to 95 parts by weight of a propylene homopolymer (which is referred to as “first polymer”), and 5 to 45 parts by weight of a propylene-α-olefin random copolymer (which is referred to as “second polymer”) containing 20 to 90% by weight of a propylene unit and 10 to 80% by weight of an α-olefin unit having four or more carbon atoms, the total of the first polymer and the second polymer being 100 parts by weight, and the total of the former propylene unit and the latter α-olefin unit being 100% by weight, and (5) a blend of two or more of those (1) to (4). Examples of the above-mentioned α-olefin having four or more carbon atoms are α-olefins having 4 to 20 carbon atoms, and specific examples thereof are 1-butene, 1-pentene, 1-hexene, 1-octene and -decene, and a combination of two or more thereof.

Examples of the above-mentioned propylene random copolymer (2) are a propylene-ethylene random copolymer, a propylene-1-butene random copolymer, and a propylene-ethylene-1-butene random copolymer.

Examples of the above-mentioned propylene-α-olefin block copolymer (4) are a propylene-1-butene block copolymer, a propylene-1-pentene block copolymer, and a propylene-1-hexene block copolymer.

An example of a process for producing the above-mentioned polymers (1) to (4) is a process using a polymerization catalyst known in the art and a polymerization method known therein. An example of the polymerization catalyst known in the art is a Ziegler-Natta catalyst obtained by combining a titanium-containing solid transition metal component with an organometallic component. Among them, preferred is a combination of a titanium-containing solid transition metal component containing a titanium atom, a magnesium atom and a halogen atom as an essential component, and an electron donor compound as an optional component with an organometallic component of an organoaluminum compound. Examples of the polymerization method known in the art are a slurry polymerization method, a gas phase polymerization method, a bulk polymerization method, a solution polymerization method, and a multi-stage polymerization method comprising an optional combination of those polymerization methods.

An example of a process for producing the above-mentioned ethylene-propylene block copolymer (3) or the above-mentioned propylene-α-olefin block copolymer (4) is a process known in the art, which comprises the steps of (i) making the first polymer with the above-mentioned Ziegler-Natta catalyst, and (ii) making the second polymer in the presence of the first polymer. Although those block copolymers (3) and (4) are usually a blend of the first polymer and the second polymer, they are generally referred to as a block copolymer according to their process characteristics. Incidentally, some parts or total of the first polymer may be chemically linked to some parts or total of the second polymer.

The above-mentioned crystalline polypropylene resin as the resin (a2) has an intrinsic viscosity of generally 0.7 to 3.0 dL/g, and preferably 0.8 to 2.7 dL/g from a viewpoint of a productivity of the modified polyolefin resin (A).

The resin (a1) in the step (1) is used in an amount of 0.1 to 100% by weight, preferably 40 to 95% by weight, and more preferably 50 to 90% by weight from a viewpoint of a productivity of the modified polyolefin resin (A), and the resin (a2) therein is used in an amount of 0 to 99.9% by weight, preferably 5 to 60% by weight, and more preferably 10 to 50% by weight from a viewpoint of a productivity of the modified polyolefin resin (A), the total amount of the resin (a1) and the resin (a2) being 100% by weight. The amount of the resin (a1) of smaller than 0.1% by weight may result in insufficient adhesion of the thermoplastic resin composition in the present invention with coating.

The unsaturated group (b1) in the compound (b) used in the present invention is preferably a carbon-to-carbon double bond, or a carbon-to-carbon triple bond.

Examples of the polar group (b2) in the compound (b) used in the present invention are a carboxyl group, an ester group, an amino group, a group having a structure of an ammonium salt derived from an amino group, an amido group, an imido group, a nitrile group, an epoxy group, a hydroxyl group, an isocyanate group, a 2-oxa-1,3-dioxo-1,3-propandiyl group, and a dihydrooxazolyl group.

Examples of the compound (b) are an unsaturated carboxylic acid, an unsaturated carboxylic ester, an unsaturated carboxylic amide, an unsaturated carboxylic anhydride, an unsaturated epoxy compound, an unsaturated alcohol, an unsaturated amine, and an unsaturated isocyanate. Specific examples of the compound (b) are those of the following groups (1) to (14). Those compounds may be used in combination of two or more thereof.

### Group (1):

Maleic acid, maleic anhydride, fumalic acid, maleimide, maleic hydrazide, methyl nadic anhydride, dichloromaleic anhydride, maleic amide, itaconic acid, itaconic anhydride, glycidyl methacrylate, glycidyl acrylate, 2-hydroxyethyl methacrylate, and allyl glycidyl ether.

### Group (2):

Compounds represented by the following formula such as a reaction product of maleic anhydride with a diamine,

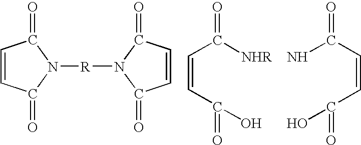

wherein R is an aliphatic group or an aromatic group.

### Group (3):

Natural oil such as soybean oil, wood oil, castor oil, flaxseed oil, hempseed oil, cotton oil, sesame oil, canola oil, earthnut oil, camellia oil, olive oil, palm oil, and sardine oil.

### Group (4):

Compounds obtained by epoxidation of the above-mentioned natural oil.

### Group (5):

Unsaturated carboxylic acid such as acrylic acid, butenoic acid, crotonic acid, vinylacetic acid, methacrylic acid, pentenoic acid, angelic acid, tiglic acid, 2-pentenoic acid, 3-pentenoic acid, α-ethylacrylic acid, β-methylcrotonic acid, 4-pentenoic acid, 2-hexene, 2-methyl-2-pentenoic acid, 3-methyl-2-pentenoic acid, α-ethylcrotonic acid, 2,2-dimethyl-3-butenoic acid, 2-heptenoic acid, 2-octenoic acid, 4-decenoic acid, 9-undecenoic acid, 10-undecenoic acid, 4-dodecenoic acid, 5-dodecenoic acid, 4-tetradecenoic acid, 9-tetradecenoic acid, 9-hexadecenoic acid, 2-octadecenoic acid, 9-octadecenoic acid, eicosenoic acid, docosenoic acid, erucic acid, tetracosenoic acid, mycolipenic acid, 2,4-hexadienoic acid, diallylacetic acid, geranic acid, 2,4-decadienoic acid, 2,4-dodecadienoic acid, 9,12-hexadecadienoic acid, 9,12-octadecadienoic acid, hexadecatrienoic acid, eicosadienoic acid, eicosatrienoic acid, eicosatetraenoic acid, recinoleic acid, eleostearic acid, oleic acid, eicosapentaenoic acid, erucinic acid, docosadienoic acid, docosatrienoic acid, docosatetraenoic acid, docosapentaenoic acid, tetracosenoic acid, hexacosenoic acid, hexacodienoic acid, and octacosenoic acid.

### Group (6):

Esters, amides or anhydride of the above-mentioned unsaturated carboxylic acids.

### Group (7):

Unsaturated alcohol such as ally alcohol, crotyl alcohol, methylvinyl carbinol, allyl carbinol, methylpropyl carbinol, 4-penten-1-ol, 10-undecen-1-ol, propargyl alcohol, 1,4-pentadien-3-ol, 1,4-hexadien-3-ol, 3,5-hexadien-2-ol, and 2,4-hexadien-1-ol.

### Group (8):

Unsaturated alcohol such as 3-buten-1,2-diol, 2,5-dimethyl-3-hexen-2,5-diol, 1,5-hexadien-3,4-diol, and 2,6-octadien-4,5-diol.

### Group (9):

Unsaturated amines obtained by substituting an amino group for a hydroxyl group of unsaturated alcohols in the above groups (7) and (8).

### Group (10):

Compound obtained by adding maleic anhydride, phenol or a phenol derivative to a low molecular weight polymer of a diene compound such as butadiene and isoprene, said low molecular weight being, for example, a number average molecular weight of about 500 to about 10,000.

### Group (11):

Compound obtained by adding maleic anhydride, phenol or a phenol derivative to a high molecular weight polymer of a diene compound such as butadiene and isoprene, said high molecular weight being, for example, a number average molecular weight of about 10,000 or higher.

### Group (12):

Compound obtained by introducing an amino group, a carboxyl group, a hydroxyl group or an epoxy group into a low molecular weight polymer of a diene compound such as butadiene and isoprene, said low molecular weight being, for example, a number average molecular weight of about 500 to about 10,000.

### Group (13):

Compound obtained by introducing an amino group, a carboxyl group, a hydroxyl group or an epoxy group into a high molecular weight polymer of a diene compound such as butadiene and isoprene, said high molecular weight being, for example, a number average molecular weight of about 10,000 or higher.

### Group (14):

Ally isocyanate.

Among them, the compound (b) is preferably maleic anhydride, maleic acid, fumalic acid, itaconic anhydride, itaconic acid, glycidyl methacrylate, glycidyl acrylate, or 2-hydroxyethyl methacrylate.

An organic peroxide (c) used in the present invention decomposes to generate a radical, which abstracts a proton from the resin (a1) or resin (a2). The organic peroxide (c) is preferably an organic peroxide having a decomposition temperature of 50 to 210° C., at which temperature its half life is one minute, in order to increase an amount of the compound (b) grafted onto the resins (a1) and (a2), and in order to prevent the resins (a1) and (a2) from decomposition.

Examples of the organic peroxide having a decomposition temperature of 50 to 210° C., at which temperature its half life is one minute, are a diacyl peroxide compound, a dialkyl peroxide compound, a peroxyketal compound, an alkyl perester compound and a percarbonate compound. Among them preferred is a diacyl peroxide compound, a dialkyl peroxide compound, an alkyl perester compound or a percarbonate compound.

Specific examples thereof are dicetyl peroxydicarbonate, di-3-methoxybutyl peroxydicarbonate, di-2-ethylhexyl peroxydicarbonate, bis(4-t-butylcyclohexyl) peroxydicarbonate, diisopropyl peroxydicarbonate, t-butyl peroxyisopropylcarbonate, dimyristyl peroxycarbonate, 1,1,3,3-tetramethylbutyl neodecanoate, α-cumyl peroxyneodecanoate, t-butyl peroxyneodecanoate, 1,1-bis(t-butylperoxy)cyclohexane, 2,2-bis(4,4-di-t-butylperoxycyclohexyl)propane, 1,1-bis(t-butylperoxy)cyclododecane, t-hexylperoxyisopropyl monocarbonate, t-butylperoxy-3,5,5-trimethyl haxonoate, t-butylperoxylaurate, 2,5-dimethyl-2,5-di(bezoylperoxy)hexane, t-butylperoxyacetate, 2,2-bis(t-butylperoxy)butene, t-butylperoxybenzoate, 4,4-di-t-butylperoxyvaleric acid n-butyl ester, di-t-butylperoxyisophthalate, dicumylperoxide, α-α′-bis(t-butylperoxy-m-isopropyl)benzene, 2,5-dimethyl-2,5-di(t-butylperoxy)hexane, 1,3-bis(t-butylperoxyisopropyl)benzene, t-butylcumylperoxide, di-t-butylperoxide, p-menthane hydroperoxide, and 2,5-dimethyl-2,5-di(t-butylperoxy)hexyne-3.

The compound (b) is used in an amount of 0.01 to 20 parts by weight, preferably 0.1 to 10 parts by weight, and more preferably 0.3 to 3 parts by weight, the total amount of the resins (a1) and (a2) being 100 parts by weight. Said amount of smaller than 0.01 part by weight may result in an insufficient amount of the compound (b) grafted onto the resins (a1) and (a2), which leads to insufficient adhesion of the thermoplastic resin composition in the present invention with coating. Said amount of larger than 20 parts by weight may result in too large residual amount of the compound (b) contained in the thermoplastic resin composition in the present invention, which also leads to insufficient adhesion of the thermoplastic resin composition in the present invention with coating.

The organic peroxide (c) is used in an amount of 0.001 to 20 parts by weight, and preferably 0.05 to 10 parts by weight, the total amount of the resins (a1) and (a2) being 100 parts by weight. Said amount of smaller than 0.001 part by weight may result in an insufficient amount of the compound (b) grafted onto the resins (a1) and (a2). Said amount of larger than 20 parts by weight may result in promotion of decomposition of the resins (a1) and (a2), which leads to insufficient adhesion of the thermoplastic resin composition in the present invention with coating.

Each of the resin (a1), the resin (a2), the compound (b) and the organic peroxide (c) may be combined with a vinyl aromatic compound such as styrene and divinylbenzene, or with an additive known in the art such as an antioxidant, a heat stabilizer and a neutralization agent. The vinyl aromatic compound is used in an amount of 0.1 to 15 parts by weight, and preferably 0.1 to 7 parts by weight, the total amount of the resins (a1) and (a2) being 100 parts by weight.

The crystalline thermoplastic resin (B) in the present invention has a peak of crystal melting heat of 1 J/g or more, preferably 30 J/g or more, or a peak of crystallization heat of 1 J/g or more, preferably 30 J/g or more, in a range of 50 to 180° C. measured by differential scanning calorimetry according to JIS K7122.

Examples of the crystalline thermoplastic resin (B) are the above-exemplified crystalline polyolefin resins as the resin (a2), an ethylene-vinyl acetate copolymer resin, an ethylene-acrylic acid copolymer resin, an ethylene-acrylic ester copolymer resin, an ethylene-methacrylic acid copolymer resin, an ethylene-methacrylic ester copolymer resin, an ethylene-glycidyl methacrylate copolymer resin, an ethylene-acrylic ester-glycidyl methacrylate copolymer resin, a polystyrene resin, a polyester resin, a polyamide resin, a polyphenylene ether resin, a polyacetal resin, a polycarbonate resin, an ethylene-cyclic olefin copolymer resin, and a combination of two or more of those resins. Among them, preferred is a polyolefin resin such as a polyethylene resin, a polypropylene resin, a polybutene resin, and a poly(4-methyl-1-pentene) resin.

An amount of the modified polyolefin resin (A) in the step (2) is 1 to 99% by weight, preferably 3 to 80% by weight, and further preferably 5 to 60% by weight, and an amount of the crystalline thermoplastic resin (B) therein is 1 to 99% by weight, preferably 20 to 97% by weight, and further preferably 40 to 95% by weight, the total amount of the modified polyolefin resin (A) and the crystalline thermoplastic resin (B) being 100% by weight. The amount of the modified polyolefin resin (A) of smaller than 1% by weight may result in no adhesion of the thermoplastic resin composition in the present invention with coating. The amount of the modified polyolefin resin (A) of larger than 99% by weight may result in insufficient mechanical properties of the thermoplastic resin composition in the present invention.

Each of the modified polyolefin resin (A) and the crystalline thermoplastic resin (B) may be combined with an organic filler such as wood fiber, carbon black, graphite, carbon fiber, carbon nanotube, and fullerene; an inorganic filer such as metal powder, silica, alumina, titanium oxide, iron oxide, zinc oxide, magnesium oxide, tin oxide, antimony oxide, barium ferrite, strontium ferrite, aluminum hydroxide, magnesium hydroxide, calcium sulfate, magnesium sulfate, barium sulfate, talk, clay, mica, calcium silicate, calcium carbonate, magnesium carbonate, calcium phosphate, glass fiber, calcium titanate, lead zirconium titanate, aluminum nitride, and silicon carbide; or an additive such as an antioxidant, an ultraviolet absorber, a lubricant, a pigment, an antistatic agent, a copper inhibitor, a fire retardant, a neutralization agent, a blowing agent, a plasticizing agent, and a nucleating agent.

Examples of a method of reacting the resin (a1), the resin (a2), the compound (b) and the organic peroxide (c) with one another in the step (1) are (i) a method of melt-kneading them, (ii) a method of heating a solution of them in an organic solvent, and (iii) a method of heating a suspension of them in water. Among them, preferred is the method (i) from an economical point of view.

Examples of a kneader used in the above-mentioned method (i) are BANBURY MIXER, LABO PLASTOMILL, BRABENDER PLASTOGRAPH, a single-screw extruder and a twin-screw extruder, which are known in the art. Among them, preferred is a single-screw extruder or a twin-screw extruder in view of continuous production (namely, high productivity).

Specific examples of the above-mentioned method (i) are:

[1] a method of melt-kneading the resin (a1), the resin (a2), the compound (b) and the organic peroxide (c) with one another in a lump sum;

[2] a method comprising the steps of (2-1] melt-kneading the resin (a1) with the resin (a2), thereby obtaining a mixture, and then [2-2] adding the compound (b) and the organic peroxide (c) to the mixture at the same time or in an optional order, and melt-kneading them with one another;

[3] a method comprising the steps of [3-1] melt-kneading a part of the resin (a1) with all the resin (a2), thereby obtaining a mixture, and then [3-2] adding the remainder of the resin (a1), the compound (b) and the organic peroxide (c) to the mixture at the same time or in an optional order, and melt-kneading them with one another;

[4] a method comprising the steps of [4-1] melt-kneading all the resin (a1) with a part of the resin (a2), thereby obtaining a mixture, and then [4-2] adding the remainder of the resin (a2), the compound (b) and the organic peroxide (c) to the mixture at the same time or in an optional order, and melt-kneading them with one another; and

[5] a method comprising the steps of [5-1] melt-kneading a part of the resin (a1) with a part of the resin (a2), thereby obtaining a mixture, and then [5-2] adding the remainder of the resin (a1), the remainder of the resin (a2), the compound (b) and the organic peroxide (c) to the mixture at the same time or in an optional order, and melt-kneading them with one another.

A melt-kneading temperature (when using an extruder, it is temperature of a cylinder thereof) is usually 50 to 300° C., and preferably 80 to 270° C., in order to increase an amount of the compound (b) grafted onto the resins (a1) and (a2), and in order to prevent those resins from decomposition.

A melt-kneading time is usually 0.1 to 30 minutes, and preferably 0.5 to 5 minutes in order to increase sufficiently an amount of the compound (b) grafted onto the resins (a1) and (a2).

Examples of a method of blending the modified polyolefin resin (A) with the crystalline thermoplastic resin (B) in the step (2) are (i) a method of blending all of those resins in a lump sum with a blender such as a Henschel mixer and a ribbon blender, or dividing respective resins into some parts and blending those parts in an optional order therewith, and (ii) a method of melt-kneading them with an apparatus known in the art such as BANBURY MIXER, LABO PLASTOMILL, BRABENDER PLASTOGRAPH, a single-screw extruder and a twin-screw extruder. Among them, preferred is a single-screw extruder or a twin-screw extruder in view of continuous production (namely, high productivity).

The steps (1) and (2) in the process of the present invention may be carried out with one and the same extruder. An example of such an embodiment comprises the steps of:

(i) blending the resins (1) and (2), the compound (b) and the organic peroxide (c) with one another, thereby obtaining a mixture;

(ii) supplying the mixture to an extruder through one or more upper inlets of the extruder, and melt-kneading the mixture in the extruder, thereby forming the modified polyolefin resin (A) (corresponding to the step (1)); and

(iii) supplying the crystalline thermoplastic resin (B) to the extruder through one or more lower inlets of the extruder, and melt-kneading the modified polyolefin resin (A) with the crystalline thermoplastic resin (B) in the extruder (corresponding to the step (2)).

A melt-kneading temperature (when using an extruder, it is temperature of a cylinder thereof) in the step (2) is usually 50 to 300° C., and preferably 80 to 270° C., in order to prevent the modified polyolefin resin (A) and the crystalline thermoplastic resin (B) from decomposition. A melt-kneading time is usually 0.1 to 30 minutes, and preferably 0.5 to 5 minutes in order to disperse sufficiently the modified polyolefin resin (A) and the crystalline thermoplastic resin (B).

An example of use of the thermoplastic resin composition produced by the process of the present invention is a non-primer material for a home building or an automobile, which can provide a good coating property or a good printing property without a surface modifier such as a primer.

### EXAMPLE

The present invention is explained with reference to the following Examples, which do not limit the scope of the present invention.

### Reference Example 1

### 1. Preparation of dimethylsilyl(tetramethylcyclopentadienyl) (3-tert-butyl-5-methyl-2-phenoxy)titanium dichloride (transition metal complex as polymerization catalyst component)

### (1) Preparation of 1-bromo-3-tert-butyl-5-methyl-2-phenol

There was dissolved 20.1 g (123 mmol) of 2-tert-butyl-4-methylphenol in 150 mL of toluene under a nitrogen atmosphere in a four-necked 500 mL flask equipped with a stirrer, and then 25.9 mL (18.0 g, 246 mmol) of tert-butylamine was added thereto. The resultant solution was cooled down to −70° C., and 10.5 mL (32.6 g, 204 mmol) of bromine was added thereto. The obtained solution was stirred for two hours at −70° C., and then was heated up to room temperature. The solution was washed three times with each 100 mL of hydrochloric acid having a 10% concentration. The washed organic layer was dried over anhydrous sodium sulfate, and then the solvent contained therein was distilled away with an evaporator. The resultant material was purified with a silica gel column, thereby obtaining 18.4 g (75.7 mmol, yield: 62%) of 1-bromo-3-tert-butyl-5-methyl-2-phenol (colorless oil).

### (2) Preparation of 1-bromo-3-tert-butyl-2-methoxy-5-methyl benzene

There was dissolved 13.9 g (52.7 mmol) of the above-prepared 1-bromo-3-tert-butyl-5-methyl-2-phenol in 40 mL of acetonitrile under a nitrogen atmosphere in a four-necked 100 mL flask equipped with a stirrer, and then 3.8 g (67.9 mmol) of potassium hydroxide was added thereto. Further, 17.8 mL (40.6 g, 286 mmol) of methyl iodide was added thereto, and the resultant mixture was stirred for 12 hours. The solvent contained in the mixture was distilled away with an evaporator. The remainder was subjected to extraction three times with each 40 mL of hexane, and the solvent contained in the extract was distilled away, thereby obtaining 13.8 g (53.7 mmol, yield: 94%) of 1-bromo-3-tert-butyl-2-methoxy-5-methyl benzene (pale yellow oil).

### (3) Preparation of (3-tert-butyl-2-methoxy-5-methylphenyl) chlorodimethylsilane

There was added dropwise at −40° C. over 20 minutes 115 mL of a hexane solution of n-butyllithium having a concentration of 1.6 mol/L to a solution containing 31.5 mL of tetrahydrofuran, 139 mL of hexane and 45 g of the above-prepared 1-bromo-3-tert-butyl-2-methoxy-5-methylbenzene. The obtained mixture was kept at −40° C. for one hour, and then 31.5 mL of tetrahydrofuran was added dropwise thereto, thereby obtaining a mixture.

There was added dropwise at −40° C. the above-obtained mixture to a solution containing 131 g of dichlorodimethylsilane and 306 mL of hexane. The obtained mixture was heated up to a room temperature over two hours, and then was stirred for 12 hours at a room temperature, thereby obtaining a reaction mixture.

The solvent and surplus dichlorodimethylsilane contained in the reaction mixture was distilled away under a reduced pressure. The remainder was subjected to extraction with hexane, and the solvent contained in the extract was distilled away, thereby obtaining 41.9 g (yield: 84%) of (3-tert-butyl-2-methoxy-5-methylphenyl)chlorodimethylsilane (pale yellow oil).

### (4) Preparation of (3-tert-butyl-2-methoxy-5-methylphenyl) dimethyl(tetramethylcyclopentadienyl)silane

There was added at −35° C. 2.73 g of tetramethylcyclopentadienyllithium to a solution containing 5.24 g of the above-prepared (3-tert-butyl-2-methoxy-5-methylphenyl)chlorodimethylsilane and 50 mL of tetrahydrofuran. The obtained mixture was heated up to a room temperature over two hours, and then stirred for ten hours at a room temperature, thereby obtaining a reaction mixture.

The solvent contained in the reaction mixture was distilled away under a reduced pressure. The remainder was subjected to extraction with hexane, and the solvent contained in the extract was distilled away, thereby obtaining 6.69 g (yield: 97%) of (3-tert-butyl-2-methoxy-5-methylphenyl)dimethyl(tetramethyl cyclopentadienyl)silane.

### (5) Preparation of dimethylsilyl(tetramethylcyclopentadienyl) (3-tert-butyl-5-methyl-2-phenoxy)titanium dichloride (polymerization catalyst component)

There was added dropwise at −70° C. 19.0 mL of a hexane solution of n-butyllithium having a concentration of 1.63 mol/L to a solution containing 10.04 g of the above-prepared (3-tert-butyl-2-methoxy-5-methylphenyl)dimethyl(tetramethyl cyclopentadienyl)silane, 100 mL of toluene and 6.30 g of triethylamine. The obtained mixture was heated up to a room temperature over two hours, and was kept at a room temperature for 12 hours, thereby obtaining a mixture.

The mixture was added dropwise at 0° C. under a nitrogen atmosphere to 50 mL of a toluene solution containing 4.82 g of titanium tetrachloride. The resultant mixture was heated up to a room temperature over one hour, and then was refluxed for ten hours, thereby obtaining a reaction mixture.

The reaction mixture was filtered, and the solvent contained in the filtrate was distilled away. The remainder was recrystallized from a toluene-hexane mixed solvent, thereby obtaining 3.46 g (yield: 27%) of dimethylsilyl(tetramethyl cyclopentadienyl)(3-tert-butyl-5-methyl-2-phenoxy)titanium dichloride (orange color column crystal) represented by the following formula.

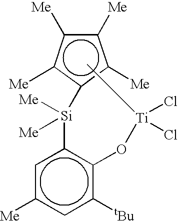

Said compound had spectrum data of:

regarding ¹H-NMR (CDCl₃), δ 0.57(s,6H), 1.41(s,9H), 2.158s,6H), 2.34(s,6H), 2.38(s,3H), 7.15(s,1H), and 7.18(s,1H);

regarding ¹³C-NMR (CDCl₃), δ 1.25, 14.48, 16.28, 22.47, 31.25, 36.29, 120.23, 130.62, 131.47, 133.86, 135.50, 137.37, 140.82, 142.28, and 167.74; and

regarding mass spectrum (CI, m/e), 458.

### 2. Preparation of Amorphous Olefin Copolymer Resin (a1)

There were continuously supplied hexane (polymerization solvent) at a rate of 100 L/hour, propylene at a rate of 24.00 kg/hour, 1-butene at a rate of 1.81 kg/hour, the above-prepared dimethylsilyl(tetramethylcyclopentadienyl)(3-tert-butyl-5-methyl-2-phenoxy)titanium dichloride (polymerization catalyst component) at a rate of 0.005 g/hour, triphenylmethyltetrakis (pentafluorophenyl)borate at a rate of 0.298 g/hour, triisobutylaluminum at a arte of 2.315 g/hour, and hydrogen (molecular weight regulator), respectively, to a bottom of a 100 L-SUS reactor equipped with a stirrer and an exterior cooling water jacket, whereby a continuous polymerization was carried out at 45° C.

A polymerization reaction mixture was continuously extracted from the top of the reactor so that the reactor held a polymerization reaction mixture in a constant amount of 100 L. A small amount of ethanol was added to the extracted polymerization reaction mixture to terminate the polymerization reaction. The resultant mixture was subjected to monomer-elimination, washing with water, and solvent-elimination with steam in a large amount of water, thereby obtaining a copolymer. The copolymer was died at 80° C. overnight under a reduced pressure to obtain a propylene-1-butene copolymer (resin (a1)). A production rate thereof was 7.10 kg/hour.

The resin (a1) contained a propylene unit in an amount of 96% by mole, and a 1-butene unit in an amount of 4% by mole, the total amount of the propylene unit and the 1-butene unit being 100% by mole. The resin (a1) did not show melting peak temperature, melting heat, crystallization peak temperature, and crystallization heat. The resin (a1) had an intrinsic viscosity of 2.5 dL/g measured with an Ubbellohde viscometer using TETRALINE as a solvent, and a molecular weight distribution (Mw/Mn) of 2.

The above-mentioned amount of the propylene unit and that of the 1-butene unit were measured with an NMR apparatus, AC-250 (trade mane), manufactured by Bruker by a method comprising the steps of:

(1) measuring a ¹³C-NMR spectrum of a sample;

(2) from the spectrum, obtaining a ratio of a spectrum strength of a carbon atom contained in a methyl group originated from the propylene unit to a spectrum strength of a carbon atom contained in a methyl group originated from the 1-butene unit; and

(3) from the ratio, obtaining an amount of the propylene unit and that of the 1-butene unit.

The above-mentioned melting peak temperature, melting heat, crystallization peak temperature, and crystallization heat were measured with a differential scanning calorimetry, DSC 220C (trade name) (input compensation DSC), manufactured by Seiko Instruments & Electronics Ltd. under the following conditons:

(1) using indium as a measurement standard material;

(2) heating about 5 mg of a sample from room temperature up to 200° C. at a rate of 30° C./minute, and keeping at 200° C. for 5 minutes;

(3) cooling from 200° C. down to −100° C. at a rate of 10° C./minute, and keeping at −100° C. for 5 minutes; and

(4) heating from −100° C. up to 200° C. at a rate of 10° C./minute.

### Example 1

### 1. Preparation of Modified Polyolefin Resin (A)

There were melt-kneaded with a Banbury mixer 85 parts by weight of the above-prepared propylene-1-butene copolymer (resin (a1)) and 15 parts by weight of a propylene-ethylene random copolymer (crystalline polyolefin resin (a2)), NOBLENE S131 (trade name), manufacture by Sumitomo Chemical Co., Ltd., having a melt flow rate of 1.5 g/10 minutes, thereby obtaining a kneaded product.

There were mixed 80 parts by weight of the above-obtained kneaded product, 20 parts by weight of NOBLENE S131 (resin (a2)), 3 parts by weight of maleic anhydride (compound (b)), 0.15 part by weight of 1,3-bis(tert-butylperoxyisopropyl)benzene (organic peroxide (c)), and 0.50 part by weight of dicetyl peroxydicarbonate (organic peroxide (c)), thereby obtaining a mixture.

The mixture was melt-kneaded with a twin-screw extruder, 2D25-S (trade name), manufactured by Toyo Seiki Co., Ltd., having (i) a length/diameter ratio (L/D) of 25, (ii) a cylinder diameter of 20 mm, and (iii) two melt-kneading zones, at its screw rotating speed of 70 rpm, thereby obtaining a modified polyolefin resin (A), temperature of the upper (first) melt-kneading zone being 180° C., and temperature of the lower (second) melt-kneading zone being 260° C. The modified polyolefin resin (A) had a melt flow rate of 8.2 g/10 minutes measured at 230° C. under a load of 21.2 N according to JIS K7210.

The modified polyolefin resin (A) contained maleic anhydride (compound (b)) grafted thereon in amount of 0.2% by weight, the total amount of the modified polyolefin resin (A) being 100% by weight, measured by a method comprising the steps of:

(1) dissolving 1.0 g of a sample in 10 mL of xylene, thereby preparing a solution;

(2) adding the solution dropwise to 300 mL of methanol under stirring, thereby reprecipitating a modified polyolefin resin;

(3) collecting the reprecipitated modified polyolefin resin;

(4) drying the collected modified polyolefin resin in vacuum at 80° C. for 8 hours;

(5) hot-pressing the dried modified polyolefin resin, thereby making a 100 μm-thick film; and

(6) measuring an infrared (IR) spectrum of the film, and determining a graft amount based on an absorption in the vicinity of 1730 cm⁻.

### 2. Preparation of Thermoplastic Resin Composition

There were blended 40% by weight of the above-prepared modified polyolefin resin (A), 22% by weight of a propylene-1-butene random copolymer (crystalline thermoplastic resin (B)), TAFMER A6050 (trade name), manufactured by Mitsui Chemicals Inc., 18% by weight of an ethylene-propylene block copolymer (crystalline thermoplastic resin (B)), NOBLENE AH161C (trade name), manufactured by Sumitomo Chemical Co., Ltd., and 20% by weight of a propylene homopolymer (crystalline thermoplastic resin (B)), NOBLENE W101 (trade name), manufactured by Sumitomo Chemical Co., Ltd., thereby producing a blend, the total amount of those components being 100% by weight.

The blend was melt-kneaded at 220° C. with the above-mentioned twin-screw extruder at its screw rotating speed of 70 rpm, thereby obtaining a thermoplastic resin composition.

The thermoplastic resin composition had excellent adhesion with coating (namely, no peeling), which was measured by a method comprising the steps of:

(1) molding the thermoplastic resin composition with an injection machine, J28SC (trade name), manufactured by the Japan Steel Works, Ltd., to make a molded article having a shape of a 50-mm-square and thickness of 3 mm;

(2) cleaning the molded article with a pure water-impregnated paper cloth;

(3) coating a paint, NP AR2000 (trade name), manufactured by Nippon Bee Chemical Co., Ltd. with an air gun on the molded article so that dried film thickness thereof is 15 μm;

(4) burning the coated film into the surface of the molded article at 80° C. for 10 minutes;

(5) coating thereon a paint, NP-1000 (trade name), manufactured by Nippon Bee Chemical Co., Ltd. with an air gun so that dried film thickness thereof is 30 μm;

(6) burning the coated film into the surface thereof at 110° C. for 20 minutes;

(7) leaving it to stand all day long;

(8) cutting the coated surface of the sample on a grid with a knife, and putting a cellophane tape (for example, adhesive tape such as SCOTCH TAPE) thereon; and

(9) peeling the cellophane tape quickly, and evaluating an adhesion property of the coating on the basis of “no peeling”, “partial peeling” and “entire peeling” (cross-cut adhesion test according to JIS K5400).

### Example 2

### 1. Preparation of Modified Polyolefin Resin (A)

There were mixed 100 parts by weight of the same kneaded product as that used in Example 1, Item 1, 12 parts by weight of 2-hydroxyethyl methacrylate (compound (b)) and 1.5 part by weight of tert-butylperoxybenzoate (organic peroxide (c)), thereby obtaining mixture.

The mixture was melt-kneaded at 18° C. with the above-mentioned twin-screw extruder at its screw rotating speed of 70 rpm, thereby obtaining a modified polyolefin resin (A).

The modified polyolefin resin (A) had a melt flow rate of 2.5 g/10 minutes measured by the same method as in Example 1, and contained 2-hydroxyethyl methacrylate (compound (b)) grafted thereon in amount of 3.2% by weight, the total amount of the modified polyolefin resin (A) being 100% by weight.

### 2. Preparation of Thermoplastic Resin Composition

There were blended 20% by weight of the above-prepared modified polyolefin resin (A), 22% by weight of a propylene-1-butene random copolymer (crystalline thermoplastic resin (B)), TAFMER A6050, 18% by weight of an ethylene-propylene block copolymer (crystalline thermoplastic resin (B)), NOBLENE AH161C, and 40% by weight of a propylene homopolymer (crystalline thermoplastic resin (B)), NOBLENE H501N (trade name), manufactured by Sumitomo Chemical Co., Ltd., thereby producing a blend, the total amount of those components being 100% by weight.

The blend was melt-kneaded at 220° C. with the above-mentioned twin-screw extruder at its screw rotating speed of 70 rpm, thereby obtaining a thermoplastic resin composition.

The thermoplastic resin composition had excellent adhesion with coating (namely, no peeling).

### Comparative Example 1

In order to compare with Example 2, the following was conducted.

There were blended 22% by weight of a propylene-1-butene random copolymer (crystalline thermoplastic resin (B)), TAFMER A6050, 18% by weight of an ethylene-propylene block copolymer (crystalline thermoplastic resin (B)), NOBLENE AH161C, and 60% by weight of a propylene homopolymer (crystalline thermoplastic resin (B)), NOBLENE H501N, without the modified polyolefin resin (A) used in Example 2, Item 2, thereby producing a blend.

The blend was melt-kneaded at 220° C. with the above-mentioned twin-screw extruder at its screw rotating speed of 70 rpm, thereby obtaining a thermoplastic resin composition.

The thermoplastic resin composition had a cross-cut adhesion test result of entire peeling.

### Comparative Example 2

In order to compare with Example 1, the following was conducted.

### 1. Preparation of Modified Polyolefin Resin

There were blended 100 parts by weight of a propylene-ethylene random copolymer (crystalline polyolefin resin (a2)), NOBLENE S131, 3 parts by weight of maleic anhydride (compound (b)), 0.15 part by weight of 1,3-bis(tert-butylperoxyisopropyl)benzene (organic peroxide (c)), and 0.50 part by weight of dicetyl peroxydicarbonate (organic peroxide (c)), thereby obtaining a blend.

The blend was melt-kneaded with the above-mentioned twin-screw extruder having two melt-kneading zones, at its screw rotating speed of 70 rpm, thereby obtaining a modified polyolefin resin, temperature of the upper (first) melt-kneading zone being 180° C., and temperature of the lower (second) melt-kneading zone being 260° C.

The modified polyolefin resin had a melt flow rate of 14 g/10 minutes measured by the same method as in Example 1, and contained maleic anhydride (compound (b)) grafted thereon in amount of 0.2% by weight, the total amount of the modified polyolefin resin being 100% by weight.

### 2. Preparation of Thermoplastic Resin Composition

There were blended 40% by weight of the above-prepared modified polyolefin resin, 22% by weight of a propylene-1-butene random copolymer (crystalline thermoplastic resin (B)), TAFMER A6050, 18% by weight of an ethylene-propylene block copolymer (crystalline thermoplastic resin (B)), NOBLENE AH161C, and 20% by weight of a propylene homopolymer (crystalline thermoplastic resin (B)), NOBLENE Y101 (trade name), manufactured by Sumitomo Chemical Co., Ltd., thereby producing a blend, the total amount of those components being 100% by weight.

The blend was melt-kneaded at 220° C. with the above-mentioned twin-screw extruder at its screw rotating speed of 70 rpm, thereby obtaining a thermoplastic resin composition.

The thermoplastic resin composition had a cross-cut adhesion test result of entire peeling.

The above-mentioned results show the following:

(1) a thermoplastic resin composition obtained by using the modified polyolefin resin (A) has excellent adhesion with coating (Examples 1 and 2); and

(2) a thermoplastic resin composition obtained by using no modified polyolefin resin (A) (Comparative Example 1), or a thermoplastic resin composition obtained by modifying only NOBLENE S131 (crystalline polyolefin resin (a2)) has poor adhesion with coating.

1. A process for producing a thermoplastic resin composition comprising the steps of:
(1) reacting with one another, at least, 0.1 to 100% by weight of an amorphous olefin copolymer resin (a1), 0 to 99.9% by weight of a crystalline polyolefin resin (a2), 0.01 to 20 parts by weight of a compound (b) containing at least one kind of an unsaturated group (b1) and at least one kind of a polar group (b2), and 0.001 to 20 parts by weight of an organic peroxide (c), thereby producing a modified polyolefin resin (A), the total amount of said resin (a1) and said resin (a2) being 100% by weight or 100 parts by weight; and
(2) blending with each other 1 to 99% by weight of said modified polyolefin resin (A) and 1 to 99% by weight of a crystalline thermoplastic resin (B), the total amount of said resin (A) and said resin (B) being 100% by weight, wherein said amorphous olefin copolymer resin (a1) has a molecular weight distribution of 1 to 4, an intrinsic viscosity of 0.5 to 10 dL/g measured at 135° C. in tetrahydronaphthalene, and crystal melting heat of 30 J/g or less in a range of −50 to 200° C. measured by differential scanning calorimetry (DSC) according to JIS K7122; said crystalline polyolefin resin (a2) has a peak of crystal melting heat of 1 J/g or more, or a peak of crystallization heat of 1 J/g or more in a range of 50 to 180° C. measured by differential scanning calorimetry according to JIS K7122; and said crystalline thermoplastic resin (B) has a peak of crystal melting heat of 1 J/g or more, or a peak of crystallization heat of 1 J/g or more in a range of 50 to 180° C. measured by differential scanning calorimetry according to JIS K7122.

2. The process for producing a thermoplastic resin composition according to claim 1, wherein the amorphous olefin copolymer resin (a1) contains polymerized monomer units derived from two or more kinds of monomers, and the number of a carbon atom of said two or more kinds of monomers is 6 or larger in total.

3. The process for producing a thermoplastic resin composition according to claim 1, wherein the amorphous olefin copolymer resin (a1) is a propylene-1-butene copolymer.

4. The process for producing a thermoplastic resin composition according to claim 1, wherein the amorphous olefin copolymer resin (a1) contains polymerized monomer units derived from two or more kinds of monomers, and all side chains contained in the polymerized monomer units have an atactic structure.

5. The process for producing a thermoplastic resin composition according to claim 1, wherein the amorphous olefin copolymer resin (a1) is an olefin copolymer having neither a peak of crystal melting heat of 1 J/g or more, nor a peak of crystallization heat of 1 J/g or more in a range of −50 to 200° C. measured by differential scanning calorimetry according to JIS K7122.

6. The process for producing a thermoplastic resin composition according to claim 1, wherein the crystalline polyolefin resin (a2) is a crystalline polypropylene resin.

7. The process for producing a thermoplastic resin composition according to claim 1, wherein the crystalline polyolefin resin (a2) is a propylene-ethylene random copolymer.

8. The process for producing a thermoplastic resin composition according to claim 1, wherein the compound (b) is maleic anhydride, maleic acid, fumalic acid, itaconic anhydride, itaconic acid, glycidyl methacrylate, glycidyl acrylate, or 2-hydroxyethyl methacrylate.

9. The process for producing a thermoplastic resin composition according to claim 1, wherein the organic peroxide (c) has a decomposition temperature of 50 to 210° C., at which temperature its half life is one minute.

10. The process for producing a thermoplastic resin composition according to claim 1, wherein the step (1) is a step of melt-kneading the amorphous olefin copolymer resin (a1), the crystalline polyolefin resin (a2), the compound (b) and the organic peroxide (c) with one another in an extruder.

11. The process for producing a thermoplastic resin composition according to claim 1, wherein the step (2) is a step of melt-kneading the modified polyolefin resin (A) with the crystalline thermoplastic resin (B) in an extruder.
